(19) United States
(12) Patent Application Publication
(10) Pub. No.: US 2004/0158741 A1
(43) Pub. Date: Aug. 12, 2004

(54) System and method for remote virus scanning in wireless networks

(76) Inventor: Peter Schneider, Helsinki (FI)

Correspondence Address: Crawford Maunu PLLC, 1270 Northland Drive, Suite 390, St. Paul, MN, 55120, US

(21) Appl. No.: 10/360,514

(22) Filed: Feb. 7, 2003

(51) Int. Cl. G06F 11/30

(52) U.S. Cl. 713/201

(57) ABSTRACT

A system and method for outsourcing received content from a user terminal for virus scanning purposes. The received content may either be received via a direct download or from peer-to-peer distribution known as superdistribution. A Digital Rights Management (DRM) agent executing within the user terminal may be provisioned with a service number or a Unique Resource Link (URL) to a network server. The DRM agent forwards content to be virus scanned to the network server and receives a notification as to the results of the scan. The DRM agent then deletes the content from the user terminal in the event that the content is virus contaminated and may request a copy of a cleaned content if the network server is capable of cleaning the content.

### FIELD OF THE INVENTION

This invention relates in general to the controlled communication of content between user terminals, and more particularly to a system and method for controlling the proliferation of virus infected content by outsourcing virus scanning services.

### BACKGROUND OF THE INVENTION

New technologies are continually emerging, enabling new types of content to be delivered over mobile networks for use with mobile terminals. The success of Short Message Service (SMS) fueled further developments such as Enhanced Messaging Service (EMS), Multimedia Messaging Service (MMS), and other communications protocols which allow the transmission of more than merely textual content. These and other new technologies allow for a variety of different types of content to be communicated to and from mobile (and landline) devices, including ringing tones, icons, Java games, video clips, software tools, Symbian applications, Smartphone applications, etc.

For the delivery of digital content to be beneficial for all parties concerned, solid methods for managing the use of the content needs to be in place. To ensure business profitability, content providers' copyrights need to be protected to provide an incentive for such providers to continue developing and publishing digital content. Content retailers include, for example, operator portals, various media companies, and entrepreneurs. On the other hand, convenience in finding, using, and paying for the digital content is of great importance to the terminal users.

The natural tendency for peer-to-peer sharing of messages, jokes, etc. is evidenced by the popularity and success of SMS and other similar technologies. The distribution of content between terminal users using such technologies, and the ultimate peer-to-peer proliferation of such content is referred to as superdistribution. With superdistribution, the content consumers themselves become the advertisers and distributors of the content, whereas the traditional manner of obtaining content involved direct access to a content provider via download servers or simple web servers. The peer-to-peer distribution of content via superdistribution creates a substantial opportunity for content providers to expand their distribution channel with relatively little administration of the distribution channel. Accordingly, superdistribution allows the content supplied by content providers to quickly proliferate the wireless community. With such highly proliferated content, however, comes the arduous task of restricting access to the content to only those consumers who have, for example, paid for or otherwise received access rights to the content.

Digital Rights Management (DRM) aims to enable such access restriction in order to protect the rights of the content creators, content publishers, content aggregators and retailers against illegal copying of the content, while protecting privacy and fair use rights of the content consumers. DRM is seen as a critical enabling technology that is essential to protect the rights of all participants. DRM not only enables protection of content, but also allows defining new sets of rules for usage, e.g., preview the content, play the content a certain number of times, use the content for a certain period of time, etc.

Today's digital content is distributed to consumers with a forward lock, thus precluding the subsequent forwarding of the content from consumer to consumer. With superdistribution, however, the forward lock is lifted allowing the digital content to be forwarded from one consumer to another. To enable one level of security, the digital content is encrypted by the content provider or content reseller, such that content that has been forwarded from one consumer to another consumer may not be used unless the recipient consumer purchases or otherwise obtains the usage rights from the content provider, operator, etc. Accordingly, the usage rights may be purchased from a content provider or content reseller via a rights object, which may contain a key to decrypt the digital content, and that may be used to decrypt digital content received from another consumer. A DRM agent local to the consumer's device, such as a wireless telephone, personal digital assistant (PDA), or other personal communicator, implements the decryption of the digital content and manages the application of usage rights granted via the rights object.

While DRM sufficiently addresses access rights to superdistributed content, DRM may not be restricting certain content that may be undesirably spreading throughout the peer-to-peer network. Viruses represent one such type of undesirable content. Unfortunately, superdistribution significantly increases the probability of spreading viruses and other malicious content within the peer-to-peer network because the viruses may proliferate themselves in the same manner as any other digital content.

The personal communicator, or mobile terminal, particularly lends itself to susceptibility of attack because of the limited resources available to the mobile terminal. In particular, a typical mobile terminal contains only a limited amount of memory space, which significantly limits the size of a virus database that could be maintained on the mobile terminal. The memory restriction limits the effectiveness of a virus scan application that may be hosted by the mobile terminal. Accordingly, a mobile terminal may only support a limited virus scan capability, if at all, which leaves it susceptible to virus attack.

Additionally, virus scan applications are computationally demanding on the mobile terminal's microprocessor due to the repeated, computation-intensive operations characteristic of virus scans. This increases power consumption and diminishes coveted battery life. Further still, new viruses are continually being discovered, which creates a formidable challenge in maintaining a current local virus database. In order to maintain an up-to-date virus database, a substantially continuous network connection would theoretically be required to obtain the most current virus definitions as they become available.

Most general purpose mobile terminals today do not have the requisite memory, power, and processing requirements to accommodate local virus scanning. More advanced mobile terminals may be able to provide virus scanning capability through their operating system and peripheral applications. However, these advanced mobile terminals still require the consumer to download virus scan updates, which requires the consumer to maintain a contract with a virus scanning software provider in order to facilitate virus signature downloads as necessary.

Accordingly, there is a need in the communications industry for a system and method for addressing virus protection for devices operating on a network, and particularly for mobile devices operating in wireless, peer-to-peer networks. The present invention fulfills these and other needs, and offers other advantages over the prior art.

### SUMMARY OF THE INVENTION

To overcome limitations in the prior art, and to overcome other limitations that will become apparent upon reading and understanding the present specification, the present invention discloses a system, apparatus and method for controlling the proliferation of virus infected content by outsourcing virus scanning services.

In accordance with one embodiment of the invention, a method is provided for providing a remote virus scanning function to a user of a terminal within a network. Such a method includes sending content to a network server from a digital rights management (DRM) agent executing within the terminal, scanning the content at the network server to identify viruses that match virus signatures provided by a virus definition repository, and providing a scan result from the network server to the DRM agent. In one embodiment, access to the content is regulated in response to the scan result.

In accordance with another embodiment of the invention, a content distribution system is provided. The content distribution system includes at least one content sending terminal to dispatch content and at least one content receiving terminal coupled to receive the content. The content receiving terminal includes a digital rights management (DRM) agent coupled to receive the content and to invoke a virus scanning operation to be remotely performed on the received content. The content distribution system further includes a network server coupled to provide the virus scanning operation(s) on the received content, and to provide an indication of a malicious or otherwise undesirable presence within the content. The content receiving terminal(s) may regulate further access to the received content in response to the indication of a malicious presence.

In accordance with another embodiment of the invention, a mobile terminal wirelessly coupled to a network containing a network element capable of performing a virus scan function is provided. The mobile terminal includes a memory capable of storing at least a digital rights management (DRM) agent, a processor coupled to the memory and configured by the DRM agent to enable transfer of content to the network element for virus scan, and a transceiver coupled to the processor to facilitate transfer of the content to the network element and to facilitate receipt of a scan result from the network element.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

The invention is described in connection with the embodiments illustrated in the following diagrams.

FIG. 1 illustrates a representative content delivery environment including both direct content distribution and peer-to-peer content distribution in accordance with the present invention;

FIG. 2 illustrates a representative digital rights management system having virus scanning outsourcing capability in accordance with the present invention;

FIG. 3 is an exemplary functional block diagram of a network server's interaction with a user terminal in support of outsource virus scan requests;

FIG. 4 is a block diagram of an exemplary networking environment in which the principles of the present invention may be practiced;

FIG. 5 illustrates a representative messaging sequence for outsourcing virus scan functionality in accordance with the present invention;

FIG. 6 is a flow diagram illustrating an exemplary method of outsourcing virus scan functionality in accordance with the present invention;

FIG. 7 illustrates a representative mobile computing arrangement suitable for initiating virus scanning functions and utilizing scanned content in accordance with the present invention; and

FIG. 8 is a representative computing system capable of carrying out virus scanning operations according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a system and method for controlling the proliferation of virus infected content by outsourcing virus scanning services. Content is generated by a content provider and proliferated within a peer-to-peer wireless network to a multitude of consumers using superdistribution. Each consumer may then forward the content from a user terminal, such as a wireless communicator or other wireless or landline device. In one embodiment of the invention, a consumer may outsource a virus scanning functionality to a network server prior to accessing the content. In such an instance, the content is first forwarded to a network operator that is running an up-to-date virus scanner. The network operator, having a current contract with a virus scanning company to provide the latest virus definitions, is then able to perform the virus scan on the content prior to the consumer's receipt. By outsourcing the virus scan of the superdistributed content, dynamic memory allocation within the mobile terminal is increased and battery consumption is reduced, while insuring an up-to-date virus scan of the superdistributed content prior to proliferation.

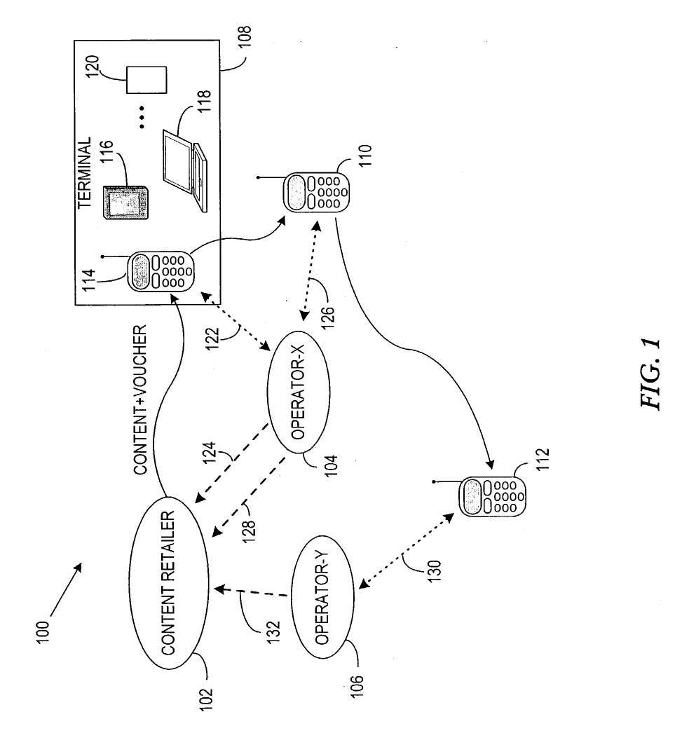

FIG. 1 illustrates a representative content delivery environment 100 including both direct content distribution and peer-to-peer content distribution. Some key components in mobile Digital Rights Management (DRM) can be described in connection with FIG. 1. A voucher server (VS) may be hosted by a content retailer 102, or an operator 104, 106 in the role of a content retailer. The VS registers the content to the mobile DRM system associated with mobile terminals 108, 110, 112, and issues vouchers. A content server (CS) which includes the downloadable content is hosted by the content retailer 102 or its content partners if it operates in aggregation mode. A DRM broker may be hosted by the payment collector, which in the illustrated embodiment is an operator 104, 106. The broker is effectively a “rights-clearing feature” in the mobile payment solution with interfaces to payment systems. In this example, the content retailer 102 (the VS and CS owner in this example) makes a payment and rights clearing agreement with the operator 104, 106 (the DRM Broker in this example), agreeing to pay a certain percentage or amount on each transaction cleared. The content retailer's VS keeps track of all the unique content it puts into circulation.

The CS owner registers each content object that it wants to import into the mobile DRM systems of the mobile terminals 108, 110, 112. Content registration involves the CS shipping the content object to the VS, which creates a unique content identifier (ID) and packages the content into a DRM-specific content package. Furthermore, the CS tells the VS what kind of usage rules can be issued for the content, such as display, execute, or print. The browsing and downloading of registered content takes place directly between the CS and the consumer, regardless of the voucher purchase process. Once downloaded, the registered content may flow freely from terminal to terminal.

When the user attempts to utilize registered content, the terminal 108, 110, 112 will check whether there is a voucher with a referring content ID in the terminal. If there is not such a voucher, the terminal will initiate a payment and rights clearing process with a payment service provider. The voucher purchase may be carried out through the DRM Broker, based on the VS address. Once the consumer agrees to pay, the DRM Broker clears the payment and asks for a voucher from the VS. The rights clearing process is completed as the DRM Broker forwards the voucher generated by the VS to the user.

In a more particular example of content transactions, the content retailer 102 issues the content plus usage rights, expressed in vouchers, to a wireless terminal 108. The wireless terminal 108 may represent any of a number of mobile communication devices, such as a cellular telephone 114, a personal digital assistant (PDA) 116, a notebook or laptop computer 118, or any other type of wireless terminal represented by device 120. The voucher is enforced at the terminal 108 (e.g., wireless telephone 114) in a manner described in greater detail below. Operator-X 104 collects the payment and optionally provides a portion of the payment back to the content retailer 102 as represented by lines 122 and 124 respectively. This transaction represents a direct content transaction from the content retailer 102 to the terminal 108.

In a peer-to-peer transaction, the content and a voucher(s) can be transferred from terminal 108 to another terminal, such as wireless telephone 110. Again, the voucher is enforced at the receiving terminal 110, and the operator-X 104 collects the payment and provides at least a portion of the payment back to the content retailer 102 as represented by lines 126 and 128 respectively. This transaction represents a peer-to-peer content transaction from wireless terminal 108 to wireless terminal 110. This distribution process can continue, such as by terminal 110 transferring the content and a voucher to terminal 112, which in turn enforces the voucher, and makes payment with operator-Y 106 as represented via line 130. Operator-Y 106 thereafter may provide at least a portion of the payment back to the content retailer 102 as represented by line 132. The use of the voucher and its local enforcement at the DRM system of each recipient terminal facilitates the secure, peer-to-peer distribution of content.

An example of a specific peer-to-peer content transfer is now described. A user of a wireless communicator, such as a mobile telephone, is at a railway station and notices an advertisement for a wireless kiosk selling a new hit song. The user takes out his wireless communicator, and sees that the wireless kiosk is visible in his browser. With a few clicks, he pays for a copy of the song, and downloads a corresponding MP3 file to his communicator. After boarding the train, he (user-1) meets a fellow traveler (user-2) and discovers that she is a music fan. User-1 transfers a copy of the new song to user-2's compliant wireless communicator, along with a voucher embodying user rights including “preview” rights to the song which allows user-2 to listen to the song a predetermined number of times without paying for it. After that, user-2 must commit to pay for the song if she wants the continued ability to listen to it. Assuming she decides to purchase the song, user-2 commits to pay for the song via her mobile communicator, and obtains further rights to listen to the song. Upon exiting the train, user-2 notices another public kiosk where she then pays for the song that she earlier committed to purchase. In this example, both kiosk-user and peer-to-peer content transfers were effected, along with the appropriate vouchers to provide either preview or full access rights. Advantageously, the vouchers ensured that the kiosk owners, as well as content owners and/or authors, received the payment for the sale of the content. This represents just one representative example of the multitude of distribution possibilities available through the implementation of vouchers and DRM management principles in accordance with the present invention.

For purposes of the transfer of content using vouchers in accordance with the invention, a compliant device is one that behaves according to the particular DRM specifications. Compliant devices may have, for example, an encryption key pair and a digital signature key pair for suitable asymmetric cryptographic schemes. Each device may also have a device certificate issued by the device manufacturer. The device certificate certifies the public keys of the device as belonging to a compliant device. Each device may also have the public signature verification key of the device manufacturer so that it can verify device certificates of other devices.

A piece of content may be associated with multiple types of rights, such as transfer rights and usage rights. Transfer rights specify policies for creating new rights for another device, and may include rights such as “give” or “copy” rights. Usage rights specify policies governing the local use of content. Rights for a piece of content are embodied in a voucher. Each piece of content may be encrypted with a content key (e.g., symmetric key). The voucher contains the content key encrypted using, for example, the public key of the target device. It also contains policies specifying how this copy of the content is to be used. Compliant devices will obey the policy restrictions specified in a voucher. When a right is transferred, the sending device creates a voucher targeted for the receiving device. A sending device verifies that the receiving device is a compliant device before creating a voucher for it. A receiving device will accept a voucher if it can verify its correctness.

A voucher being transferred may contain, among other things, a description of the content and a description of the “rights” associated therewith. The voucher may also include a content encryption key encrypted using, for example, the public encryption key of the receiver. Sequence numbers used to ensure freshness may also be provided in a voucher, as well as a message authentication code (MAC) on other fields, using the content encryption key. In one embodiment, when a compliant receiving device is asked to import a voucher, it verifies the validity of the voucher by extracting the content encryption key, and then checking the MAC. Using such mechanisms ensures that only compliant devices be allowed to acquire and redistribute rights.

In one embodiment of the invention, peer-to-peer transfer of content between terminals 108, 110, and 112 may first be transferred to Operator-X 104 or Operator-Y 106 for virus scanning purposes. Operator-X 104 or Operator-Y 106 may provide access to, for example, a download server (not shown) that is responsible for scanning superdistributed content that is transferred between terminals 108, 110, and 112. The scanning operation allows, for example, Operator-X 104 and Operator-Y 106 to serve as intermediaries between terminals 108, 110, and 112, such that content found to be infected by a virus may be quarantined within terminals 108, 110, and 112. Once quarantined, the content containing the virus may either be cleaned or discarded in order to prevent proliferation of infected content.

The DRM agent in terminals 108, 110, and 112 send superdistributed content to network servers within Operator-X 104 and Operator-Y 106, via lines 122, 126, or 130, respectively. A network server operating within Operator-X 104 or Operator-Y 106, receives the encrypted content and decrypts the encrypted content using its decryption keys. Once decrypted, the network server scans the content against an up-to-date virus database and returns a virus scanning result message to the terminal. If the content is found to be virus infected, the DRM agent of the sending terminal is informed and the content is deleted, cleaned, or otherwise contained. If the content is not found to be infected by a virus, it is forwarded to the DRM agent of the receiving terminal. The DRM agent of the receiving terminal may notify the user, such as by displaying a message that the content has been checked for virus infection, providing an audible indication, etc. In any event, the DRM agent may then decrypt the content with the rights object.

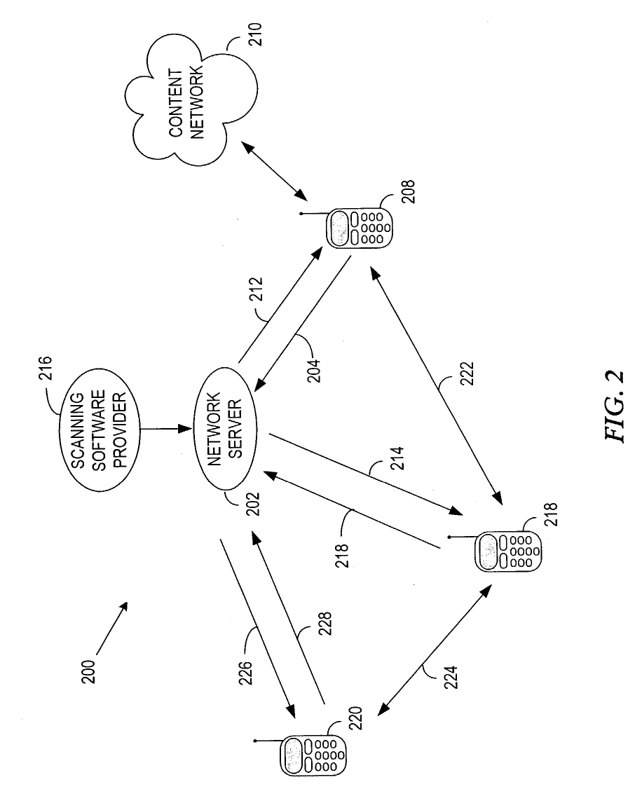

FIG. 2 illustrates a representative DRM system 200 having virus scan outsource capability, whereby superdistributed content flows from one terminal to another terminal with an optional step of performing a virus scan on the superdistributed content.

Content network 210 is representative of a typical DRM system consisting of, for example, content development, content packaging, content delivery servers, rights assignment and voucher creation, and point of sale centers. Content development is the origination point of the digital content file, where the digital content file may represent for example music, images, movies, e-books, ringing tones, games, multimedia applications, Java applets, Symbian applications, Smartphone applications, etc.

Encryption, such as through the use of symmetric key technology, is handled by the content packaging portion of content network 210. One example of symmetric key technology is the advanced encryption standard (AS), where once the content is encrypted, it is considered safe even for free distribution, since only the content encryption key (CEK) has to be carefully protected. The rights assignment and voucher creation portion of content network 210 contains the CEK, related usage rights of the content, e.g., use once, use many times, copy, modify, and a reference to the encrypted content package called a voucher. Usage rights are typically expressed either with extensible markup language (XML) based, rights expression languages (REL) or other methods.

The point of sale of content network 210 may represent, for example, a retail store listing available content for purchase. The retail store typically verifies that a particular consumer, e.g., terminal 208, has purchased the rights to open the content package. Once payment verification is established, the voucher is encrypted using the consumer's public key, based on asymmetric encryption to achieve a higher level of security.

In order for terminal 208 to be able to open the content package, terminal 208 requires both the content package and the voucher containing the rights and the CEK. Terminal 208 uses its private key to open the encrypted voucher and obtain the CEK, which terminal 208 then uses to obtain access to the encrypted digital content. Once the digital content has been decrypted, terminal 208 is free to use the content as desired. Terminal 208 may also forward the encrypted content to other consumers, e.g., 218, for limited usage prior to purchase according to the assigned forwarding usage rights. For example, the point of sale provider of the purchased content may have given terminal 208 authority to forward the purchased content to other consumers on a trial basis as defined by the forwarding usage rights, e.g., two free uses prior to voucher payment.

In accordance with the present invention, however, terminal 208 may elect to provide the content to network server 202 via line 218, where network server 202 is considered to be a compliant device behaving according to the particular DRM specifications. In particular, network server 202 may be implemented, for example, by a content download server (CDS), which scans the content received via line 218 for known viruses, where the virus definitions are provided by scanning software provider 216. Network server 202 in combination with scanning software provider 216, therefore, are considered to provide an exemplary network service arranged to receive outsourced virus scan requests along with the corresponding content to be scanned via lines 204, 218, and 228, and to subsequently provide the status of such a virus scan back to the requester.

Scanning software provider 216 may represent, for example, an anti-virus laboratory, which provides up-to-date virus definitions and signatures to the virus database (not shown) contained within network server 202. As such, network server 202 and scanning software provider 216 relieve terminals 208, 218, and 220, of the responsibility of providing local scanning functionality, which ultimately conserves power, processing time, and dynamic memory utilized by terminals 208, 218, and 220.

In response to an outsourced virus scan request from terminal 208, for example, network server 202 issues a scan response signal via line 212. The scan response signal either verifies that the content provided by terminal 208 is virus free or that viruses were found within the content. If viruses were found within the content, the DRM agent executing within terminal 208 may delete or otherwise prohibit access to the infected content. In one embodiment, the DRM agent deletes the content, and then requests that the content be cleaned at network server 202 where a copy of the cleaned content is subsequently forwarded to terminal 208 from network server 202. Once terminal 208 is in possession of a virus free copy of content, then terminal 208 is free to propagate the content to terminals 218 and 220 in accordance with the forwarding usage rights associated with the content.

Terminals 218 and 220 represent other consumers within DRM system 200 that participate in the superdistribution function of DRM system 200. Superdistributed content is transferred between terminals 208, 218, and 220 via lines 222 and 224, respectively. Optional virus scan requests that are outsourced to network server 202 are facilitated by lines 204, 218, and 228 from terminals 208, 218, and 220, respectively, as discussed above.

It should be noted that the present invention may also be used in environments where superdistribution is not used. The invention may be utilized for content received at a terminal by direct downloading from a server, removable memory, etc.

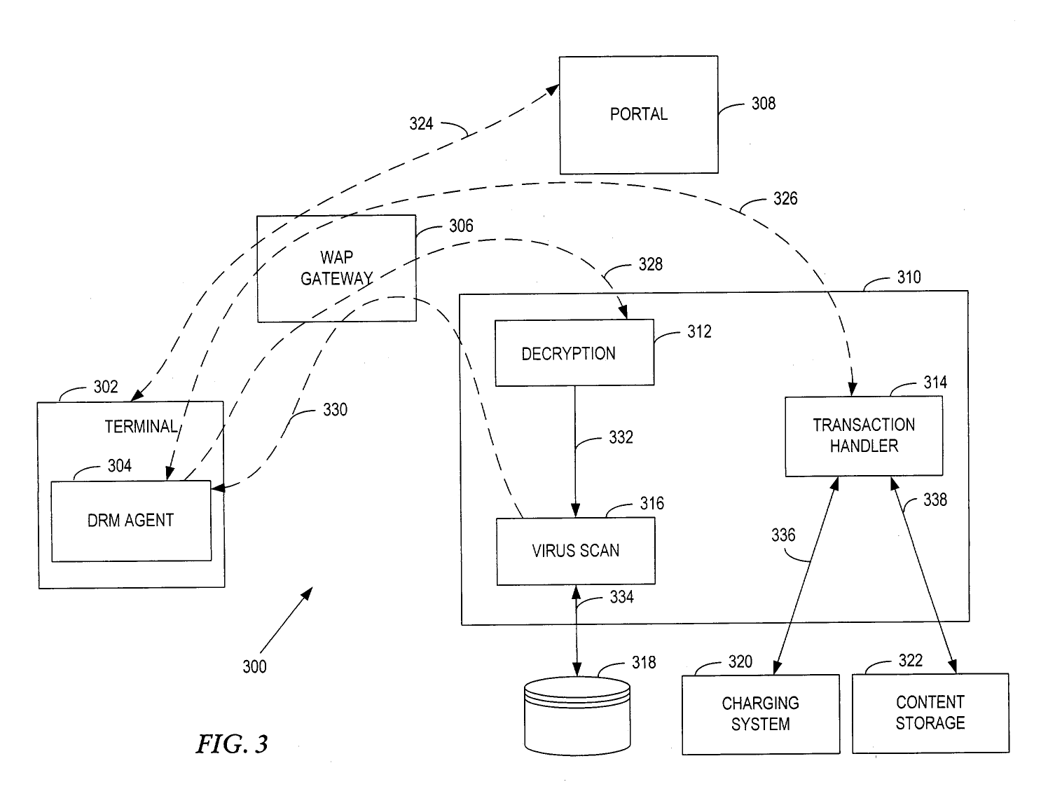

FIG. 3 represents an exemplary functional block diagram 300 of a network server's interactions with a user terminal in support of outsourced virus scan requests. Network server 310 interacts with terminal 302 to perform, among other functions, virus scanning functions on content received from terminal 302 via line 328. Transaction handler 314 of network server 310 receives, among other requests, virus scan requests from DRM agent 304. Additionally, network server 310 may function as a download server to facilitate content downloads from content storage 322 and to provide billing information to charging system 320.

In one embodiment of the present invention, network server 310 may be implemented using a content delivery server (CDS). CDS 310 manages business rules for content download, fetches content from a content storage 322 and delivers it reliably to terminal 302. Additionally, CDS 310 generates the billing data needed by charging system 320 in order to properly reconcile a consumer's account for the delivered content. CDS 310 also provides the decryption 312 and virus scan 316 functions as required to support the virus scanning outsourcing that may be required by terminal 302.

In operation, terminal 302 may peruse portal 308 for interesting content via, for example, Wireless Application Protocol (WAP) gateway 306 and line 324. It should be noted that the content may be sent without such a gateway 306, and the use of WAP gateway 306 represents one possibility. For example, it is possible to send the content over HTTP, TCP/IP, and the like, without a WAP gateway or any gateway or proxy. Once the desired content has been found, terminal 302 may select either a “buy” or “download” link from the panel or display of terminal 302. DRM agent 304 then sends a download request via line 326 to transaction handler 314, which then authenticates terminal 302 and authorizes the transaction. Transaction handler 314 then locates the content requested by terminal 302 within content storage 322 for subsequent delivery to terminal 302 via lines 338 and 326.

In addition to providing download server functionality, CDS 310 offers network-based, content virus scanning. In other words, terminal 302 may utilize CDS 310 as a network based, virus scanning service node, within the network, to scan content prior to superdistribution so as to minimize proliferation of virus infected content. A scan request is sent by DRM agent 304 to transaction handler 314 prior to transmission of the content to be scanned. Once the transaction is authenticated and authorized, the correct billing information for the virus scanning transaction is submitted to charging system 320 so that the consumer's account may be correctly reconciled in response to performing the requested virus scan.

DRM agent 304, operating in conjunction with terminal 302, prepares the content to be virus scanned for transmission to decryption module 312 of CDS 310. The content prepared by DRM agent 304 may be any content currently resident within terminal 302, whether it be content received via superdistribution, or content received from a direct download into terminal 302. In one embodiment, content received by CDS 310 is first decrypted by decryption module 312 in accordance with DRM specifications. The decrypted content is then delivered to the virus scan module 316 via line 332 for virus signature identification. Virus scan 316 receives up-to-date virus definitions from database, or repository, 318 so that the virus scans performed against the virus definitions contained within database 318 are substantially up to date.

Virus scan 316 reports the status of the virus scans performed on content received from terminal 302. The virus scanning result is reported as shown on line 330 to DRM agent 304 and indicates whether the content scanned contains a virus or is malicious in any way. If the content scanned contains a virus, DRM agent 304 is informed of the virus or malicious software. Upon receiving affirmation of the existence of a virus or malicious software, DRM agent 304 may delete the copy of the infected content from memory that is local to terminal 302. DRM agent 304 may then request a cleaned copy of the content from virus scan 316, if virus scan 316 has the capability of removing the virus from the scanned content. If virus scan 316 is not capable of cleaning the content, then terminal 302 may retrieve another copy of the content from content storage 322, or alternatively, by superdistribution from other compliant terminals.

In one embodiment of the invention, DRM agent 304 of terminal 302 may be configured to query the user as to whether remote virus scanning is to be conducted for each content item received, or whether automatic virus scanning is to be performed. In another embodiment of the invention, terminal 302 may optionally provide an indication to the user as to the status of the virus scan. Various alert modes exist within terminal 302 to communicate to the user that a virus scan has either passed or failed. Status may be reported graphically through a display of terminal 302 or other visual means, and/or audibly through the use of tones presented to a speaker contained within terminal 302. Alternatively, mechanical devices, such as a vibrating mechanism, may be used for inaudible alert. In any case, DRM agent 304 may be configured as discussed above to initiate a virus scanning operation of the content, with or without user intervention and may be configured to report the results of the virus scan to the user.

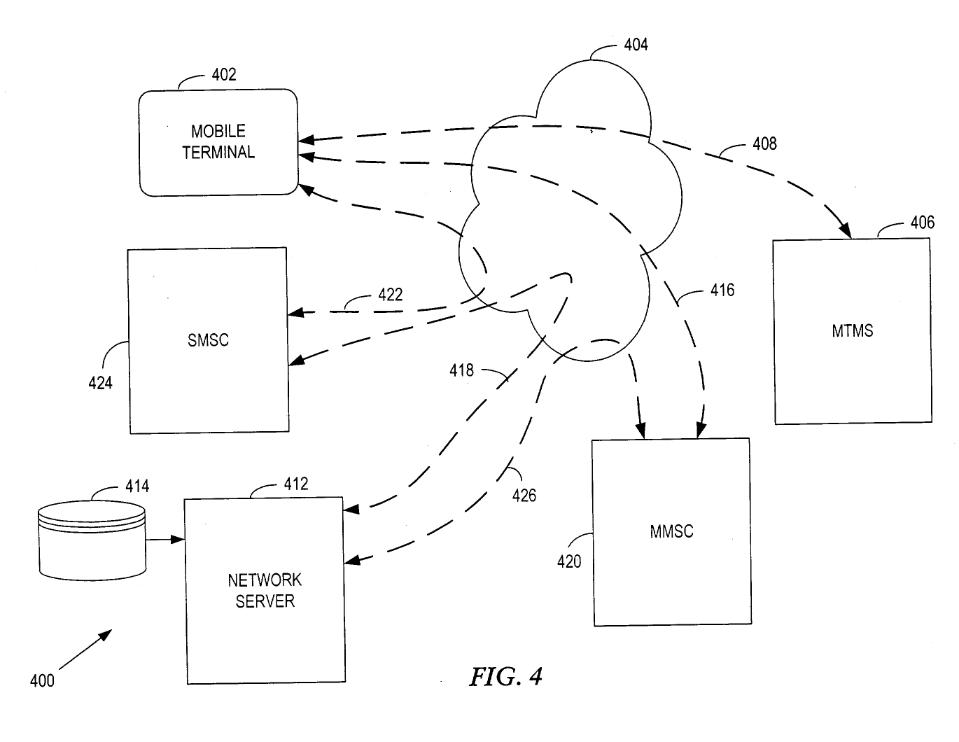

FIG. 4 illustrates an exemplary networking environment 400 in which the principles of the present invention may be practiced. In particular, a networking environment is presented with respect to the provisioning of mobile terminal 402, such that mobile terminal 402 may be interoperative with network server 412 to initiate a virus scan on received content and to receive the results of the virus scan, where the virus scanning function is performed by network server 412. The following describes a provisioning example whereby mobile terminal 402 may be activated to outsource virus scanning capabilities according to the present invention.

In this example, an International Mobile Equipment Identity (IMEI) is associated with mobile terminal 402 and an International Mobile Subscriber Identity (IMSI) is associated with a consumer, or subscriber, in possession of mobile terminal 402. At power up, the IMSI/IMEI pair relating to the subscriber and corresponding mobile terminal 402 may be automatically detected by network 404 and collectively analyzed in order to detect a new affiliation between the subscriber and a particular mobile terminal. In this manner, the network automatically detects mobile terminals that need provisioning. Alternatively, provisioning may be manually initiated by the user, or automatically initiated upon power up of the terminal. Upon detecting a mobile terminal requiring provisioning, the network initiates transmission of a notification including both the subscriber and equipment information to a provisioning server, for example, Mobile Terminal Management Server (MTMS) 406 using a suitable protocol and technology.

By comparing the IMEI to a database of corresponding IMEIs and mobile terminal models, MTMS 406 determines how mobile terminal 402 is to be configured. A provisioning message is returned to terminal 402, as depicted by dashed line 408. Depending on the provisioning message content, mobile terminal 402 may contact MTMS 406 using a predetermined protocol to obtain further provisioning information. Upon completion of the provisioning process, mobile terminal 402 may access services, such as a Multimedia Messaging Service (MMS) provided via the Multimedia Message Service Center (MMSC) 420. The availability of this service to mobile terminal 402 is illustrated by line dashed 416. Additionally, a Short Message Service (SMS) as provided by Short Message Service Center (SMSC) 424 may also be made available to mobile terminal 402 as indicated by dashed line 422. Any other appropriate communication methodology may also be utilized, such as such as Enhanced Messaging Service (EMS), General Packet Radio Service (GPRS), etc.

Network server 412, in combination with database 414, illustrates an exemplary network service that provides virus scan outsourcing capability, as discussed above in relation to FIG. 3. Mobile terminal 402 may outsource content to network server 412 via any of a number of protocols, such as the representative protocols illustrated in FIG. 4 including MMS and SMS, via MMSC 420 and SMSC 424, respectively. The particular mode of access available to the mobile terminal 402 may be a function of the provisioning parameters provided to mobile terminal 402 by MTMS 406.

In the illustrated embodiment of FIG. 4, mobile terminal 402 may be provisioned with information regarding MMS access to MMSC 420, or alternatively, with SMS access to SMSC 424. In particular, mobile terminal 402 is provisioned with the service number associated with network server 412, so that the DRM agent within mobile terminal 402 may initiate content transfer to network server 412 for virus scan purposes. Alternatively, the DRM agent may be provisioned with the Unique Resource Link (URL) that is associated with network server 412. In any case, once provisioned, mobile terminal 402 is enabled to browse network 404 for interesting content and to provide the content to network server 412 for virus scanning purposes. Network server 412 receives virus signature updates at regular intervals from database 414, in order to facilitate up-to-date virus scanning for the content provided by mobile terminal 402.

It should be noted that an identification of the network server 412 need not be provisioned in advance. In other embodiments, the network server identification may be provided to a terminal by way of the content itself. For example, a URL for a virus scanning service may be provided in a download descriptor such as a Java Application Descriptor or Download Descriptor file.

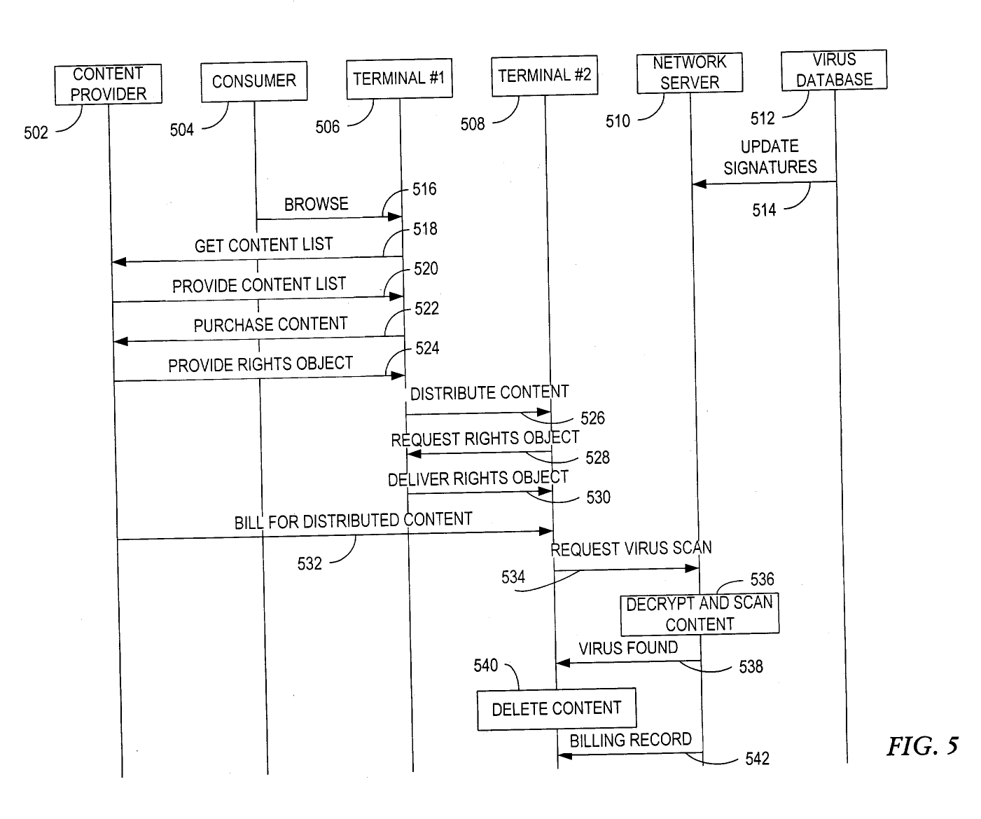

FIG. 5 illustrates an exemplary messaging sequence in accordance with the principles of the present invention. Understanding of the messaging sequence illustrated in FIG. 5 may be enhanced when taken in light of the discussion concerning the operation of the virus scanning system illustrated, for example, in the block diagram of FIG. 3.

Virus database 512 provides virus signature definitions to network server 510 via message 514 as required whenever new virus signatures become available. Network server 510 is operating as a virus scanning service provider that receives outsourced virus scan requests on superdistributed content, or directly downloaded content, according to the present invention. Since virus signature updates from virus database 512 are regularly made available as in message 514, network server 510 is able to provide content checks against the most recent virus signature definitions so that a substantially up to date virus scan may be performed.

Consumer 504, via terminal #1 506, requests to read available content from content provider 502 by issuing browse request 516 to terminal #1 506. Consumer 504 is then able to peruse interesting content contained within content provider 502 for potential purchase. It should be noted that in the messaging sequence of FIG. 5, content provider 504 and network server 510 are illustrated as separate entities. Content provider 502, for example, may then be a network server as illustrated by network server 310 of FIG. 3, with the exception that decryption 312 and virus scan 316 would not exist within content provider 502. Transaction handler 314 in combination with charging system 320 and content storage 322, however, do exist within content provider 502 in order to support the browsing, downloading, and billing services required to complete a content purchase sequence as illustrated by message flows 516-524.

In particular, the content list contained within content provider 502 is requested in message 518 and subsequently provided in message 520. Consumer 504, via terminal #1 506, selects and purchases interesting content in message 522 and is then provided the usage rights object in message 524. Once message 524 is complete, consumer 504 is granted full usage rights of the purchased content in accordance with the usage rights object received in message 524.

One of the usage rights granted to consumer 504 may be the right to forward purchased content to other consumers/terminals within the network. Content transfer from terminal #1 506 to terminal #2 508 is accomplished in message 526, whereby encrypted content is said to be superdistributed. In order for terminal #2 508 to decrypt the received content, it must have available the forwarding usage rights associated with the forward content and the CEK contained within the rights object as delivered in message 530 and requested in message 528.

Once the consumer associated with terminal #2 508 has optionally previewed the forwarded content if such rights are provided, he may wish to purchase the content either before or after the forwarding usage rights have expired. Accordingly, terminal #2 508 may purchase the content from content provider 502, similarly as illustrated in messages 522 and 524 for terminal #1, where billing is reconciled in message 532 between content provider 502 and terminal #2 508. As such, proper controls and limitations are provided to limit, if not eliminate, the occurrence of pirated content resulting in loss revenues for all entities concerned with content creation and delivery.

Terminal #2 508, after receiving the -superdistributed content from terminal #1 506, may elect to forward the content to network server 510 as in message 534. In one embodiment of the present invention, the requested virus scan may be selected by terminal #2 508 to occur automatically, e.g., without a request from a consumer associated with terminal #2 508. In another embodiment of the invention, the consumer associated with terminal #2 508 may first be prompted or queried as to his wish to perform a virus scan on the content. Message 534 thus results if in one embodiment an automatic virus scan is requested, or if in another embodiment, a consumer has elected in the affirmative to outsource content to network server 510 for virus scan. Network server 510 then must decrypt the encrypted content received in message 534 and scan the decrypted content as in step 536.

In the event that a virus has been found in the scanned content, affirmation of the virus is forwarded to terminal #2 508 in message 538. In one embodiment of the invention, a billing record may be created and sent to terminal #2 508 in message 542 for later reconciliation. In another embodiment of the invention, status of the virus found, as reported in message 538, is prompted for review by the consumer associated with terminal #2 508.

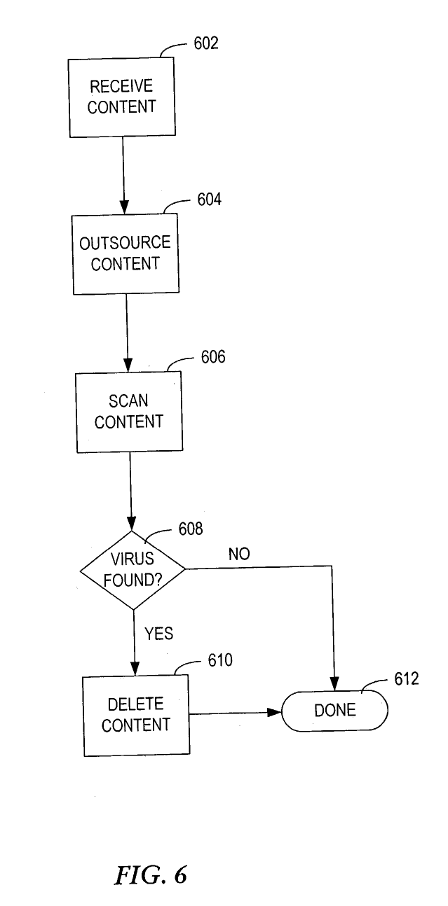

FIG. 6 illustrates a flow diagram according to the principles of the present invention. Step 602 denotes receiving of content by a DRM engine executing within a terminal from either another terminal, e.g., superdistributed, or via download from any other network device, such as a download server, or the like. The content may be distributed from the receiving terminal to a network server, such as a download server, or for example, to a Multi-Media Service Center, capable of receiving content to be virus scanned as in step 604. In one embodiment of the invention, the outsourced content may be automatically sent to the network server for virus scanning, or conversely, the user in receipt of the content may be prompted for a determination as to whether the content is to be outsourced for virus scanning.

If content is to be scanned, step 606 is executed by the designated network server by, for example, first decrypting the outsourced content and then scanning the decrypted content for viruses as defined by a virus signature database. The virus signature database being kept up-to-date by an anti-virus laboratory. Determination of whether the content is virus infected occurs in step 608, where a positive identification of infected content results in deletion in step 610. In other words, the DRM engine executing within the terminal receives notification that the content is virus infected, and proceeds to delete the local copy of the content contained within the terminal. In one embodiment of the invention, the DRM engine may request a cleaned copy of the content from the network server performing the virus scan, if a cleaned copy is available from the network server. In any case, one embodiment of the invention involves deleting the infected content from the terminal's memory, in order to prevent virus infection at the terminal and/or proliferation of infected content by the terminal.

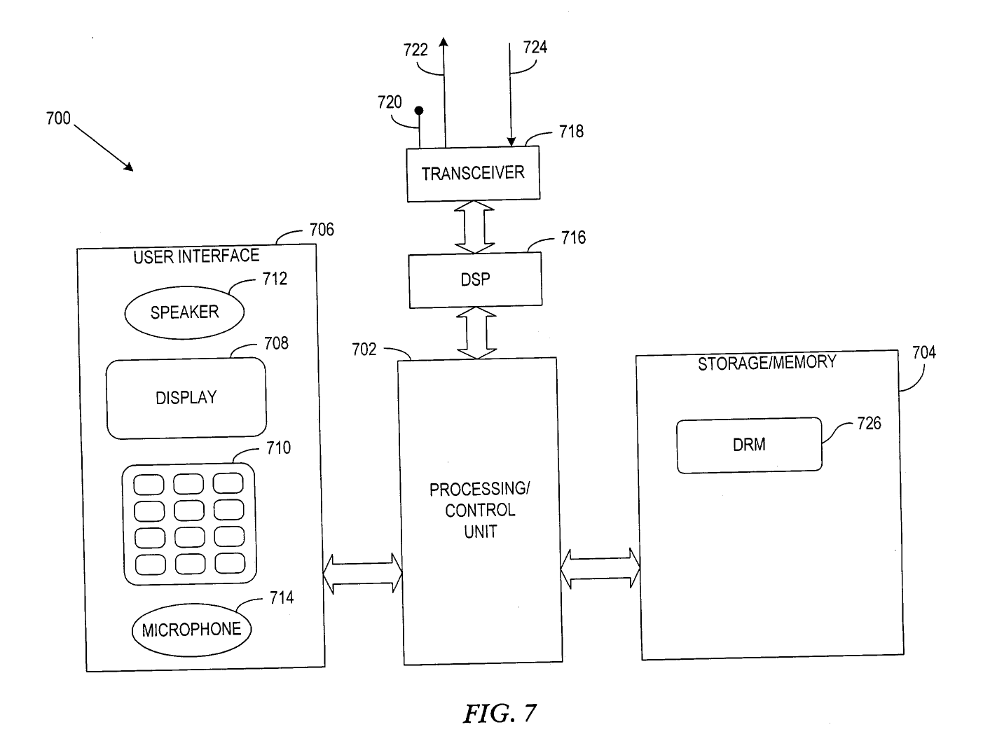

The present invention may be used to facilitate virus scans of content provided by any type of device that can communicate with the network or other connection. Such devices include computing devices such as desktop computers, workstations, laptop computers, or any other computing system capable of accessing content via a network. Such computing devices also include network servers, such as content servers, storage servers, Multimedia Messaging Service Centers (MMSC) for Multimedia Messaging Service (MMS), Short Message Service Centers (SMSC) for Short Message Service (SMS), or any other network element capable of communicating with other systems and devices over a network, such as the Internet. These devices also include mobile devices, where network access is accomplished via a wireless network that may or may not ultimately be coupled to a landline network. These mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various virus scan operations described herein. An example of a representative mobile terminal computing system capable of carrying out operations in accordance with the invention is illustrated in FIG. 7. Those skilled in the art will appreciate that the exemplary mobile computing environment 700 is merely representative of general functions that may be associated with such mobile devices, and also that landline computing systems similarly include computing circuitry to perform such operations.

Is The exemplary mobile computing arrangement 700 suitable for initiating virus scanning functions in accordance with the present invention may be associated with a number of different types of wireless devices. The representative mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the mobile terminal, and also those functions associated with the present invention as dictated by DRM agent 726 available in the program storage/memory 704. Thus, the processing unit 702 is capable of initiating virus scan functions associated with the present invention. More particularly, the program storage/memory 704 may include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. In one embodiment of the invention, the program modules associated with the storage/memory 704 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The processor 702 is also coupled to user-interface 706 elements associated with the mobile terminal. The user-interface 706 of the mobile terminal may include, for example, a display 708 such as a liquid crystal display, a keypad 710, speaker 712, and microphone 714. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The mobile computing arrangement 700 also includes conventional circuitry for performing wireless transmissions. A digital signal processor (DSP) 716 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 718, generally coupled to an antenna 720, transmits the outgoing radio signals 722 and receives the incoming radio signals 724 associated with the wireless device.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a virus scanning system and method in accordance with the present invention.

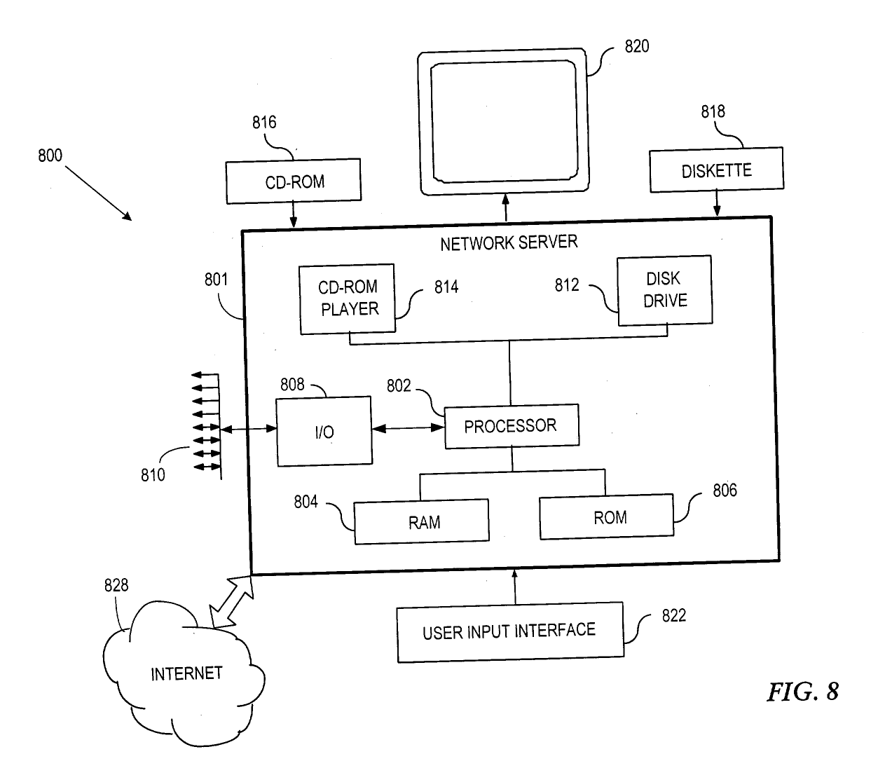

The network servers or other systems for providing virus scanning functions in connection with the present invention may be any type of computing device capable of processing and communicating scanned information. The network servers utilize computing systems to control and manage the virus scanning activity. An example of a representative computing system capable of carrying out operations in accordance with the invention is illustrated in FIG. 8. Hardware, firmware, software or a combination thereof may be used to perform the various virus scanning functions and operations described herein. The computing structure 800 of FIG. 8 is an example computing structure that can be used in connection with such a virus scanning system.

The example computing arrangement 800 suitable for performing the virus scanning activity in accordance with the present invention includes the network server 801, which includes a central processor (CPU) 802 coupled to random access memory (RAM) 804 and read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. External data storage devices, such as virus signature definition databases, may be coupled to I/O circuitry 808 to facilitate virus signature identification according to the present invention. Alternatively, such databases may be locally stored in the storage/memory of the server 801, or otherwise accessible via a local network or networks having a more extensive reach such as the Internet 828. The processor 802 carries out a variety of functions as is known in the art, as dictated by software and/or firmware instructions.

The server 801 may also include one or more data storage devices, including hard and floppy disk drives 812, CD-ROM drives 814, and other hardware capable of reading and/or storing information such as DVD, etc. In one embodiment, software for carrying out the virus scanning operations in accordance with the present invention may be stored and distributed on a CD-ROM 816, diskette 818 or other form of media capable of portably storing information. These storage media may be inserted into, and read by, devices such as the CD-ROM drive 814, the disk drive 812, etc. The software may also be transmitted to the presence server 801 via data signals, such as being downloaded electronically via a network, such as the Internet. The server 801 is coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

The server 801 may be coupled to other computing devices, such as the landline and/or wireless terminals via a network. The server may be part of a larger network configuration as in a global area network (GAN) such as the Internet 828, which allows ultimate connection to the various landline and/or mobile client/watcher devices.

The foregoing description of the various embodiments of the invention have been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A method for providing a remote virus scanning function to a user of a terminal within a network, comprising:
sending content to a network server from a digital rights management (DRM) agent executing within the terminal;
scanning the content at the network server to identify viruses that match virus signatures provided by a virus definition repository;
providing a scan result from the network server to the DRM agent; and
regulating access to the content in response to the scan result.

2. The method of claim 1, wherein sending content to the network server comprises automatically sending the content without user intervention.

3. The method of claim 1, wherein sending content to the network server comprises sending the content in response to a user intervention.

4. The method of claim 1, wherein sending content to a network server comprises accessing a Wireless Application Protocol (WAP) gateway.

5. The method of claim 1, wherein sending content to a network server comprises communicating using at least one of a Short Message Service (SMS), an Enhanced Messaging Service (EMS), a Multimedia Messaging Service (MMS), and a General Packet Radio Service (GPRS).

6. The method of claim 5, further comprising provisioning the terminal with a service number associated with the network server prior to sending the content.

7. The method of claim 5, further comprising provisioning the terminal with a Unique Resource Link (URL) associated with the network server prior to sending the content.

8. The method of claim 5, further comprising providing identification information for identifying the network server with the content received at the terminal.

9. The method of claim 1, further comprising provisioning the terminal with a service number associated with the network server prior to sending the content.

10. The method of claim 1, further comprising provisioning the terminal with a Unique Resource Link (URL) associated with the network server prior to sending the content.

11. The method of claim 1, further comprising providing identification information for identifying the network server with the content received at the terminal.

12. The method of claim 1, wherein scanning the content comprises decrypting the content prior to scanning.

13. The method of claim 12, wherein the decrypted content is provided to a virus scanning function for comparison against virus signatures.

14. The method of claim 13, wherein the virus signatures include up-to-date virus definitions.

15. The method of claim 13, wherein the comparison against virus signatures results in a scan result.

16. The method of claim 15, wherein the scan result indicates the existence of a malicious presence within the content.

17. The method of claim 1, wherein providing the scan result comprises accessing the WAP gateway from the network server to report the scan result to the DRM agent.

18. The method of claim 1, wherein the DRM agent optionally signals the scan result to the user via the terminal.

19. The method of claim 18, wherein the signaling comprises visually alerting the user to the scan result.

20. The method of claim 18, wherein the signaling comprises audibly alerting the user to the scan result.

21. The method of claim 1, wherein regulating access to the content comprises deleting the content from the terminal.

22. The method of claim 21, further comprising obtaining a cleaned copy of the content from the network server.

23. A content distribution system, comprising:
at least one content sending terminal to dispatch content;
at least one content receiving terminal coupled to receive the content, wherein the content receiving terminal comprises a digital rights management (DRM) agent coupled to receive the content and to invoke a virus scanning operation to be remotely performed on the received content; and
a network server coupled to provide the virus scanning operation on the received content and to provide an indication of a malicious presence within the content, wherein the at least one content receiving terminal regulates further access to the received content in response to the indication of a malicious presence.

24. The content distribution system of claim 23, further comprising a download server coupled to provide content to the at least one content receiving terminal.

25. The content distribution system of claim 23, further comprising a scanning software provider coupled to the network server to provide up-to-date virus signatures.

26. The content distribution system of claim 23, further comprising a Wireless Application Protocol (WAP) gateway coupled to the at least one content receiving terminal to provide access to the network server.

27. The content distribution system of claim 26, wherein a Short Message Service Center (SMSC) is coupled to the WAP gateway to provide SMS messaging.

28. The content distribution system of claim 26, wherein a Multi-Media Message Service Center (MMSC) is coupled to the WAP gateway to provide MMS messaging.

29. A mobile terminal wirelessly coupled to a network which includes a network element capable of performing a virus scan function, the mobile terminal comprising:
a memory capable of storing at least a digital rights management (DRM) agent;
a processor coupled to the memory and configured by the DRM agent to enable transfer of content to the network element for virus scan; and
a transceiver configured to transfer the content to the network element and to receive a scan result from the network element.

30. The mobile terminal of claim 29, wherein the mobile terminal receives the content via the transceiver from other mobile terminals operating within the network.

31. The mobile terminal of claim 29, wherein the mobile terminal receives the content via the transceiver from a download server operating within the network.

32. The mobile terminal of claim 29, wherein the DRM agent instigates automatic transfer of received content to the network element for virus scan.

33. The mobile terminal of claim 29, wherein the DRM agent provides an option as to whether content is to be transferred to the network element for virus scan.

34. The mobile terminal of claim 29, wherein the DRM agent provides an option as to whether the scan result is to be reported to a user of the mobile terminal.

35. The mobile terminal of claim 34, wherein the scan result is reported visually to the user.

36. The mobile terminal of claim 34, wherein the scan result is reported audibly to the user.

37. A computer-readable medium having instructions stored thereon which are executable by a computing system for providing virus scan functionality to a terminal operable on a wireless network by performing steps comprising:
transmitting content from a digital rights management (DRM) agent executing on the terminal to a network element coupled to the wireless network;
scanning the content at the network element to identify viruses inflicting the transmitted content;
providing a scan result from the network element to the DRM agent; and
regulating access to the content at the terminal in response to the scan result.
